(19) United States
(12) Patent Application Publication
(10) Pub. No.: US 2024/0114251 A1
(43) Pub. Date: Apr. 4, 2024

(54) SERVER DEVICE AND PROGRAM

(71) Applicant: Morpho, Inc., Tokyo (JP)

(72) Inventor: Michihiro KOBAYASHI, Chiyoda-ku, Tokyo (JP)

(73) Assignee: Morpho, Inc., Tokyo (JP)

(21) Appl. No.: 17/766,583

(22) PCT Filed: Oct. 6, 2020
(86) PCT No.: PCT/JP2020/037869

§ 371 Date: Apr. 5, 2022

(30) Foreign Application Priority Data
Oct. 7, 2019 (JP) 2019-184598

(51) Int. Cl. H04N 23/84; H04N 23/81; H04N 23/85; H04N 23/88

(52) U.S. Cl. CPC H04N 23/843; H04N 23/81; H04N 23/85; H04N 23/88

(57) ABSTRACT

A server device includes: a reception unit configured to receive a RAW image from a terminal; and an image pipeline processing unit configured to develop the RAW image, wherein the image pipeline processing unit has: a first image processing unit configured to performing one or more image processes including at least pixel value adjustment on the RAW image and outputting an image-processed RAW image; and a second image processing unit configured to perform one or more image processes including at least demosaic on the RAW image image-processed by the first image processing unit and outputting a developed image.

### TECHNICAL FIELD

The present disclosure relates to a server device and a program for performing image processing.

### BACKGROUND ART

Many edge devices, such as smartphones and tablets, include cameras. Users can enjoy viewing captured images on the edge devices. In an edge device with limited resources, a RAW image output from an image sensor is input and a series of image processing groups are performed to generate a developed RGB image or an encoded JPEG image. Such a series of image processing groups are designed to be sequentially processed with an output in image processing at the previous stage as an input in image processing at the subsequent stage, and are also generally referred to as image pipeline processing. Patent Document 1 discloses how an image signal processor (ISP) mounted on an edge device performs image pipeline processing.

### CITATION LIST

### Patent Document

Patent Document 1: Japanese Unexamined Patent Publication No. 2017-514384

### SUMMARY OF INVENTION

### Technical Problem

In recent years, in image pipeline processing, image processing, such as pixel value adjustment, has come to be performed at the RAW image stage instead of the demosaic RGB image stage. Since the RAW image has a larger amount of information than the RGB image or the like, performing image processing at the RAW image stage contributes to improving the image quality. However, due to the complexity of image pipeline processing, the ISP as a platform is also required to have a high processing capacity.

The present disclosure has been made in view of the aforementioned problems, and it is an object of the present disclosure to provide a server device capable of easily performing image pipeline processing that enables an output of a high-quality image.

### Solution to Problem

A server device according to the present disclosure includes: a reception means for receiving a RAW image from a terminal; and an image pipeline processing means for developing the RAW image. The image pipeline processing means has: a first image processing means for performing one or more image processes including at least pixel value adjustment on the RAW image and outputting an image-processed RAW image; and a second image processing means for performing one or more image processes including at least demosaic on the RAW image image-processed by the first image processing means and outputting a developed image.

### Advantageous Effects of Invention

According to the present disclosure, there is an effect that it is possible to easily perform image pipeline processing that enables an output of a high-quality image.

### BRIEF DESCRIPTION OF DRAWINGS

FIG. 1 is a block diagram showing some of the functions of an image signal processor according to the prior art.

FIG. 2 is a block diagram showing an example of a system configuration according to an embodiment.

FIG. 3 is a block diagram showing the hardware configuration of a terminal and a server according to an embodiment.

FIG. 4 is a block diagram showing an example of the function of a terminal according to a first embodiment.

FIG. 5 is a block diagram showing an example of the function of a server according to the first embodiment.

FIG. 6 is a flowchart showing a virtual image pipeline process according to the first embodiment.

FIG. 7 is a block diagram showing an example of the function of a server according to a second embodiment.

FIG. 8 is a schematic diagram showing a state of compositing processing and interpolation processing according to the second embodiment.

FIG. 9 is a flowchart showing a virtual image pipeline process according to the second embodiment.

FIG. 10 is a block diagram showing an example of the function of a terminal according to a third embodiment.

FIG. 11 is a block diagram showing an example of the function of a server according to the third embodiment.

FIG. 12 is a diagram showing an example of a parameter table according to the third embodiment.

FIG. 13 is a diagram showing an example of a parameter table according to the third embodiment.

FIG. 14 is a flowchart showing a virtual image pipeline process according to the third embodiment.

### DESCRIPTION OF EMBODIMENTS

[Example of Prior Art]

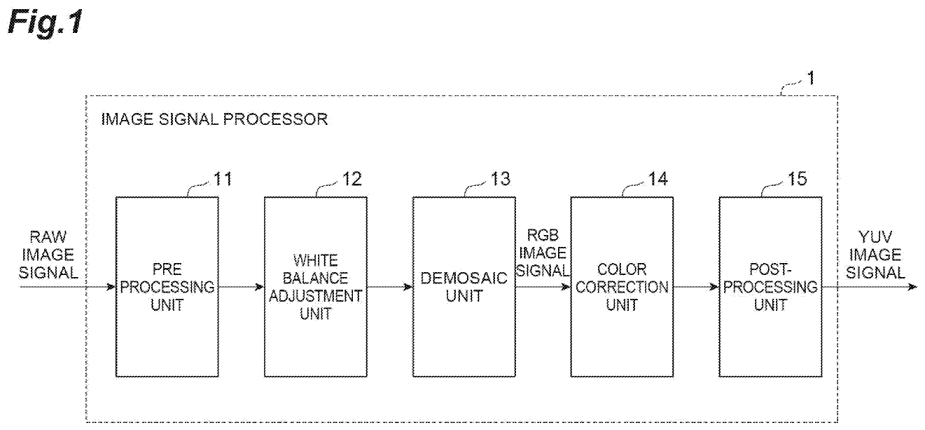

Prior to the description of an embodiment, an outline of image pipeline processing in the prior art will be described with reference to FIG. 1. FIG. 1 is a block diagram showing a functional example of an image signal processor 1 according to the prior art. The image signal processor 1 includes a pre-processing unit 11, a white balance adjustment unit 12, a demosaic unit 13, a color correction unit 14, and a post-processing unit 15. The pre-processing unit 11, the white balance adjustment unit 12, the demosaic unit 13, the color correction unit 14, and the post-processing unit 15 are connected in this order to perform pipeline processing on the input RAW image signal. The image signal processor 1 is a semiconductor chip, such as an ASIC (Application Specific Integrated Circuit) or an FPGA (Field-Programmable Gate Array).

RAW image signals are sequentially input to the pre-processing unit 11 in accordance with the operation of the device on which the image signal processor 1 is mounted. For example, when this device is a smartphone, RAW image signals output from an image sensor (not shown) are sequentially input to the pre-processing unit 11. The pre-processing unit 11 performs pre-processing on the input RAW image signals. The pre-processing is processing for generating image data suitable for viewing from the RAW image signal, and is, for example, defect pixel correction processing or black level adjustment processing. The RAW image signals output from the pre-processing unit 11 are sequentially input to the white balance adjustment unit 12. The white balance adjustment unit 12 performs white balance adjustment processing on the input RAW image signals. The RAW image signals output from the white balance adjustment unit 12 are sequentially input to the demosaic unit 13. The demosaic unit 13 generates image signals of three channels R, G, and B from the input RAW image signals. The RGB image signals output from the demosaic unit 13 are sequentially input to the color correction unit 14. The color correction unit 14 performs color correction processing on the input RGB image signals. The color correction processing is processing for adjusting the difference between the sensitivity of the image sensor and the human eye's sensation, and is, for example, color matrix correction processing or a gamma correction processing. The RGB image signals output from the color correction unit 14 are sequentially input to the post-processing unit 15. The post-processing unit 15 performs post-processing on the input RGB image signals. The post-processing is processing for generating image data suitable for operation and display on a smartphone, and is, for example, processing for conversion from an RGB image signal to a YUV image signal, noise removal processing, and edge enhancement processing. The smartphone can generate a JPEG image by encoding the YUV image signal. The JPEG image has a high compression rate and accordingly, can be appropriately used for operation and display on a smartphone.

### First Embodiment

Hereinafter, various embodiments will be described in detail with reference to the diagrams.

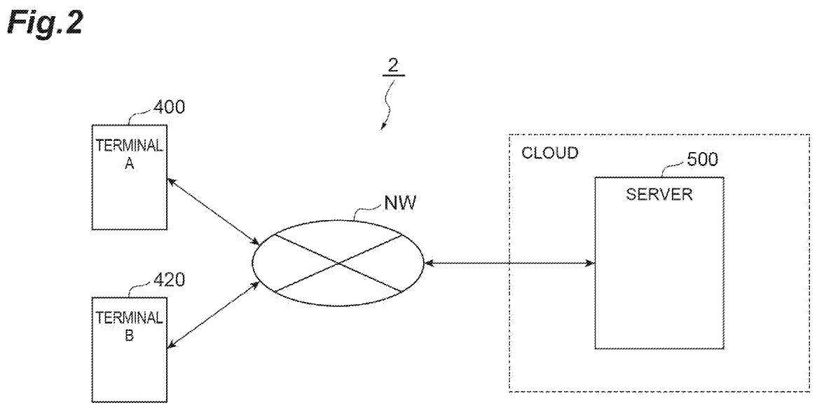

FIG. 2 is a block diagram showing a configuration example of a system 2 to realize virtual image pipeline processing according to a first embodiment. The system 2 is configured such that a terminal A400, a terminal B420, and a server 500 (an example of a server device) can communicate with each other through a network NW. The terminal A400 and the terminal B420 are information processing devices, and are, for example, mobile terminals with limited resources, such as a mobile phone, a digital camera, and a PDA (Personal Digital Assistant), or computer systems. In the example of FIG. 2, it is assumed that the terminal A400 and the terminal B420 are different models and different image sensors are mounted on the terminal A400 and the terminal B420. The server 500 performs predetermined processing in response to a request from the terminal A400 and the terminal B420. The server 500 transmits the processing result to the terminal A400 and the terminal B420 through the network NW. As described above, the server 500 may be a cloud server that provides a so-called cloud service. In addition, the configuration of the system 2 shown in FIG. 2 is an example, and the number of terminals and the number of servers are not limited to this.

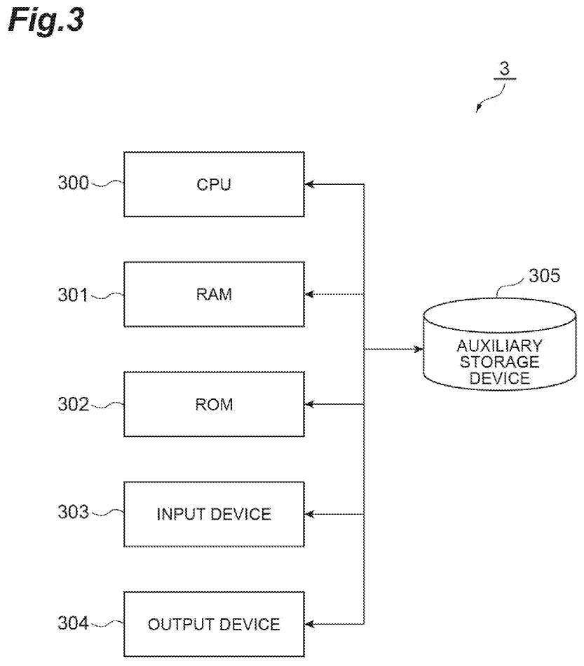

FIG. 3 is a block diagram showing the hardware configuration of the terminal A400, the terminal B420, and the server 500 according to the first embodiment. As shown in FIG. 3, each of the terminal A400, the terminal B420, and the server 500 is configured as a normal computer system including a CPU (Central Processing Unit) 300, a main storage device such as a RAM (Random Access Memory) 301 and a ROM (Read Only Memory) 302, an input device 303 such as a camera or a keyboard, an output device 304 such as a display, and an auxiliary storage device 305 such as a hard disk.

Each function of the terminal A400, the terminal B420, and the server 500 is realized by loading predetermined computer software on the hardware, such as the CPU 300, the RAM 301, and the ROM 302, and by operating the input device 303 and the output device 304 and reading and writing data in the main storage device or the auxiliary storage device 305 under the control of the CPU 300. Each of the terminal A400 and the terminal B420 may include a communication module and the like.

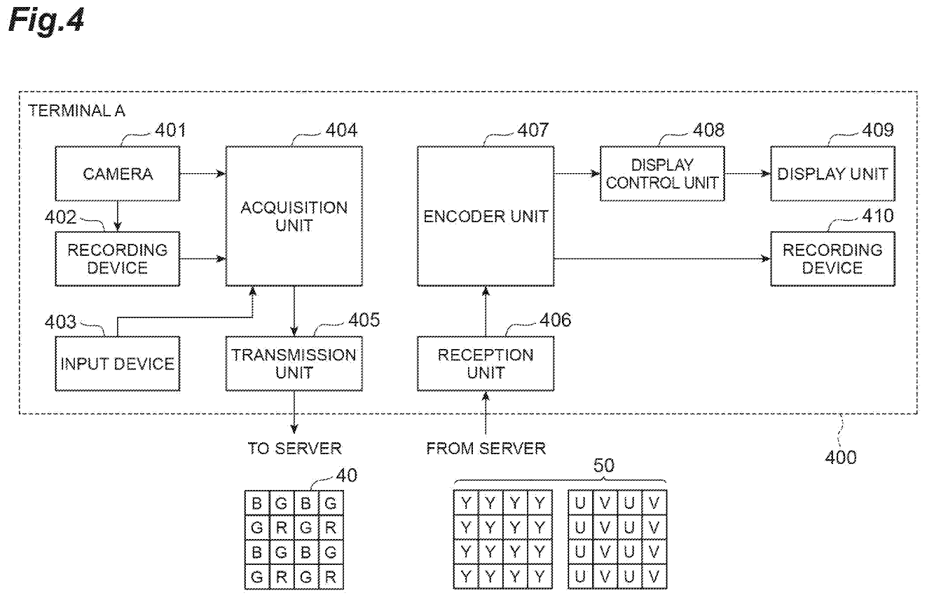

FIG. 4 is a block diagram showing an example of the function of the terminal A400 according to the first embodiment. FIG. 4 shows an example of the function of the terminal A400, but the same applies to the function of the terminal B420. The terminal A400 includes a camera (imaging unit) 401, a recording device 402 and 410, an input device 403, an acquisition unit 404, a transmission unit 405, a reception unit 406, an encoder unit 407, a display control unit 408, and a display unit 409.

The camera 401 is a device for capturing an image. As the camera 401, for example, a CMOS (Complementary Metal-Oxide Semiconductor) image sensor or the like is used. The recording device 402 is, for example, a recording medium such as a hard disk. The recording device 402 may record an image captured in the past. The input device 403 receives various inputs by the user operation. The information input by the user operation may be, for example, an instruction relevant to virtual image pipeline processing described later or a set value relevant to imaging by the camera 401.

The acquisition unit 404 acquires a RAW image 40 from the camera 401 or the recording device 402. The RAW image 40 is a RAW image of a Bayer array. In the terminal A400, a color separation filter is provided on the image sensor of the camera 401 in order to capture a color image. In a typical Bayer type color separation filter, R (red), G (green), and B (blue) color separation filters are arranged in a checkered flag shape corresponding to the pixels of the image sensor. The image output from the image sensor through such a color separation filter has an RGB array and accordingly, is generally treated as a RAW image.

The transmission unit 405 transmits the RAW image 40 to the server 500.

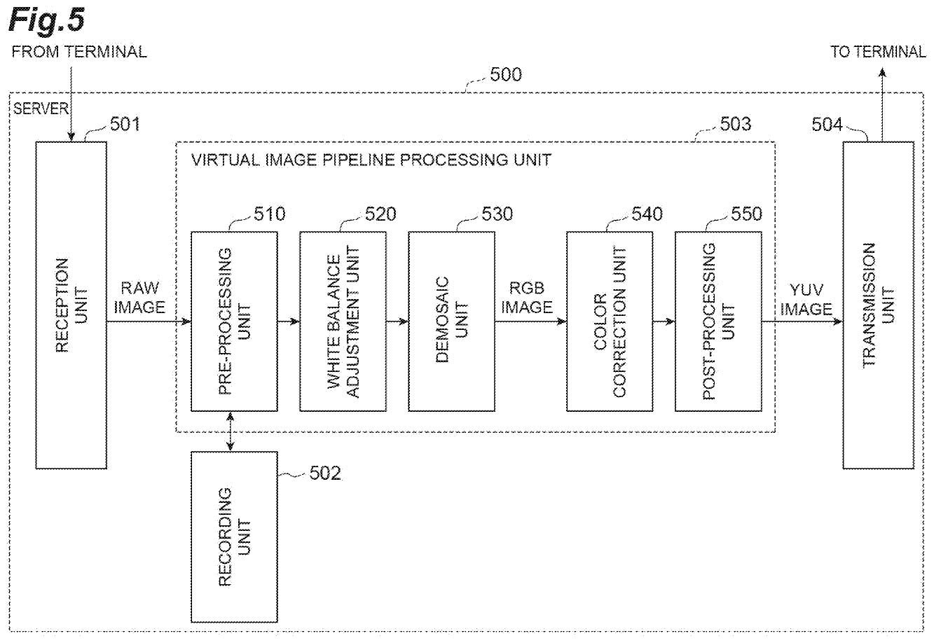

FIG. 5 is a block diagram showing an example of the function of the server 500 according to the first embodiment. The server 500 includes a reception unit 501, a recording unit 502, a virtual image pipeline processing unit 503, and a transmission unit 504.

The reception unit 501 has a function of receiving the RAW image 40 from the terminal A400. The reception unit 501 has a function of inputting the RAW image 40 into the virtual image pipeline processing unit 503 in a predetermined processing unit (for example, a line, a macro block, or a page).

The virtual image pipeline processing unit 503 receives a RAW image as an input, performs a series of image processing groups, and outputs a YUV image (color difference image) suitable for compressing the amount of data. The virtual image pipeline processing unit 503 includes a pre-processing unit 510, a white balance adjustment unit 520, a demosaic unit 530, a color correction unit 540, and a post-processing unit 550. In the present embodiment, an example in which a YUV image is output has been described. However, the virtual image pipeline processing unit 503 may output an RGB image without performing color space conversion from an RGB image to a YUV image, which will be described later. In addition, the virtual image pipeline processing unit 503 may perform encoding processing, which will be described later, and output a JPEG image. Generally, receiving a RAW image as an input, performing a series of image processing groups, and outputting an image in a format suitable for operation is called development. It can be said that the virtual image pipeline processing unit 503 of the present embodiment also has a function of performing development processing.

The pre-processing unit 510 performs pre-processing on the RAW image input from the reception unit 501. The pre-processing is processing for generating image data suitable for viewing from the RAW image, and is, for example, defect pixel correction processing or black level adjustment processing.

The RAW images output from the pre-processing unit 510 are sequentially input to the white balance adjustment unit 520. The white balance adjustment unit 520 has a function of performing white balance adjustment on the input RAW image and outputting an adjusted RGB image to the demosaic unit 530 at the subsequent stage. The white balance adjustment is processing for adjusting the color balance of an image in order to accurately display white even when the image is captured by using a light source having various color temperatures. Specifically, the balance between R, G, and B color components is adjusted by multiplying the R color component and the B color component by the gain so that the values of the R, G, and B color components in the image data have a predetermined relationship.

The RAW images output from the white balance adjustment unit 520 are sequentially input to the demosaic unit 530. The demosaic unit 530 performs demosaic processing on the RAW image of a Bayer array to separate the RAW image into RGB images of three channels. For the demosaic processing, for example, a known bilinear interpolation method or the like can be used.

The RGB images output from the demosaic unit 530 are sequentially input to the color correction unit 540. The color correction unit 540 performs color correction processing on the input RGB images. The color correction processing is processing for adjusting the difference between the sensitivity of the image sensor and the human eye's sensation, and is, for example, color matrix correction processing or a gamma correction processing.

The RGB images output from the color correction unit 540 are sequentially input to the post-processing unit 550. The post-processing unit 550 performs post-processing on the input RGB images. The post-processing is processing for generating an image suitable for operation and display on a smartphone, and is, for example, processing for color space conversion from an RGB image to a YUV image. Specifically, the post-processing unit 550 has a function of converting the color space expressing an image from the RGB color space to the YUV color space and outputting a YUV image expressed in the YUV color space to the transmission unit 504 at the subsequent stage. The post-processing unit 550 can obtain the output of YUV data by multiplying the R color component, the G color component, and the B color component of each pixel by a predetermined coefficient. A specific example of the conversion expression using the coefficient is shown below.

Y=0.299·R+0.587·G+0.114·B

U=−0.169·R−0.3316·G+0.500·B

V=0.500·R−0.4186·G−0.0813·B

In addition, as post-processing, noise removal processing and edge enhancement processing may be performed on the converted YUV image.

The transmission unit 504 transmits a YUV image 50 processed by the virtual image pipeline processing unit 503 to the terminal A400. The transmission unit 504 may have a function of outputting the YUV image 50, which is to be transmitted to the terminal A400, to the recording unit 502.

Returning to FIG. 4 again, the reception unit 406 of the terminal A400 has a function of receiving the YUV image 50 from the server 500. The reception unit 406 has a function of inputting the YUV image 50 to the encoder unit 407 in a predetermined processing unit (for example, a line, a macro block, or a page).

The encoder unit 407 has a function of performing predetermined encoding on the YUV image 50 and outputting a compressed image (for example, a JPEG image) to the display control unit 408 and the recording device 410 at the subsequent stage. In the encoding processing, first, the encoder unit 407 performs a discrete cosine transform or a discrete wavelet transform for each processing unit of the YUV image 50. Then, the encoder unit 407 performs encoding for each processing unit on which the conversion processing has been performed, thereby obtaining a JPEG image. For this encoding, Huffman coding, arithmetic coding, and the like are used.

The display control unit 408 is connected to the encoder unit 407 and the display unit 409. The display control unit 408 controls the display on the display unit 409. The display unit 409 is connected to the display control unit 408, and displays the content controlled by the display control unit 408. The display unit 409 is, for example, a display.

[Virtual Image Pipeline Process]

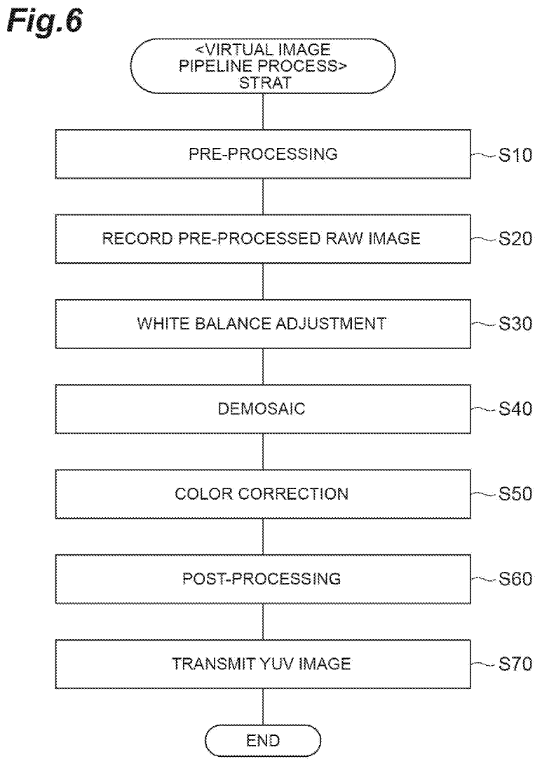

Next, the operation of the server 500 will be described. FIG. 6 is a flowchart showing a virtual image pipeline process of the server 500 according to the first embodiment. The virtual image pipeline process shown in FIG. 6 starts, for example, when the reception unit 501 receives the RAW image 40 from the terminal A400.

In S10, the pre-processing unit 510 performs pre-processing on the RAW image input from the reception unit 501.

In S20, the pre-processing unit 510 records the pre-processed RAW image in the recording unit 502.

Generally, a RAW image (pure RAW image) immediately after being output from the image sensor is not suitable for viewing by the human eye. The pre-processing unit 510 can convert the RAW image received from the terminal A400 into a RAW image, which can be viewed by the user, by performing black level adjustment processing or the like. The virtual image pipeline process of the present embodiment may be started not only when the reception unit 501 receives the RAW image 40 from the terminal A400 but also when the user operation is input to the input device 403 of the terminal A400. In this case, the virtual image pipeline processing unit 503 can call the RAW image selected by the user operation from the recording unit 502 to perform processing after the white balance adjustment. By configuring the virtual image pipeline processing unit 503 in this manner, the user can develop a desired RAW image at a desired timing. When the user can change the settings in the virtual image pipeline processing unit 503 through the input device 403, the output after the processing by the white balance adjustment unit 520 to the post-processing unit 550 can be obtained based on the changed settings.

In S30, the white balance adjustment unit 520 performs white balance adjustment on the pre-processed RAW image.

In S40, the demosaic unit 530 performs demosaic processing on the RAW image of a Bayer array to separate the RAW image into RGB images of three channels.

In S50, the color correction unit 540 performs color correction processing on the input RGB images.

In S60, the post-processing unit 550 performs post-processing on the input RGB images. When the color space conversion is performed by the post-processing unit 550, the post-processing unit 550 converts the RGB image into a YUV image and outputs the converted YUV image.

In S70, the transmission unit 504 transmits the YUV image 50 processed by the virtual image pipeline processing unit 503 to the terminal A400.

According to the present embodiment, the server 500 has a function of performing virtual image pipeline processing. Then, the server 500 receives the RAW image 40 from the terminal A400, performs virtual image pipeline processing (development processing) on the received RAW image 40, and transmits the output to the terminal A400. Thus, since the high-load image pipeline processing is performed on the server side, it is not necessary to mount the ISP having a high processing capacity on the terminal. Therefore, the cost of the terminal can be suppressed. In addition, since a server having a higher processing capacity than the ISP performs the image pipeline processing, it is possible to simplify the processing on the terminal side while enabling the output of a high-quality image.

According to one embodiment, the server 500 has the recording unit 502 that records the RAW image 40 received from the terminal A400. Therefore, the virtual image pipeline processing unit 503 reads the RAW image 40 from the recording unit 502 not only at the timing when the RAW image 40 is received from the terminal A400 but also at a predetermined timing, and the development processing in the virtual image pipeline processing unit 503 can be performed.

### Second Embodiment

Since the RAW image has a larger amount of information than the RGB image or the like, performing image processing on the RAW image contributes to improving the image quality. In the present embodiment, a method of obtaining a high-quality output image while simplifying the processing on the terminal A400 side by making the virtual image pipeline processing unit 503 perform image processing at the RAW image stage multiple times will be described. In addition, in the following description and each diagram, the same or equivalent elements are denoted by the same reference numerals, and the same description will not be repeated.

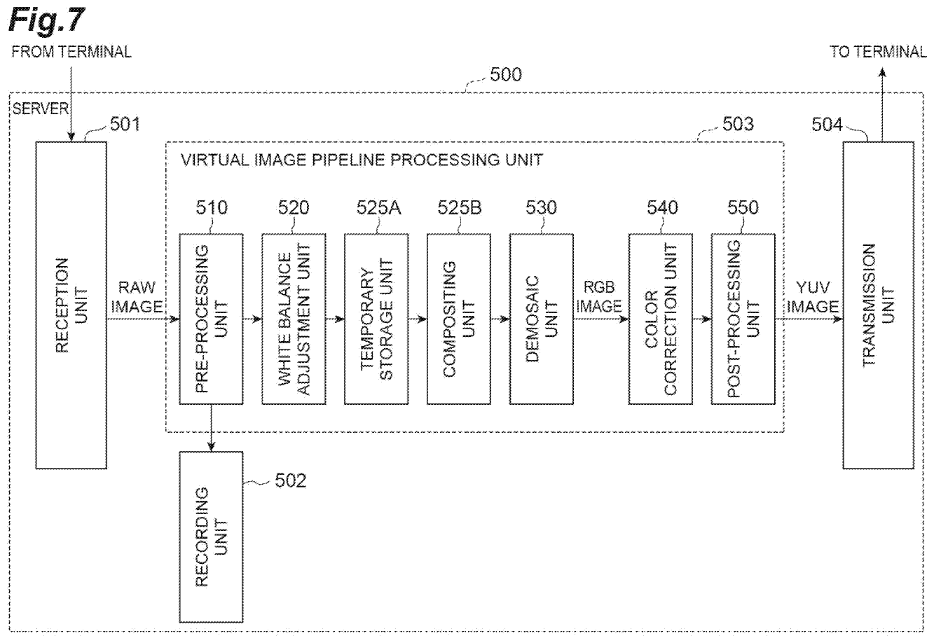

FIG. 7 is a block diagram showing an example of the function of a server 500 according to a second embodiment. A virtual image pipeline processing unit 503 in the second embodiment includes a temporary recording unit 525A and a compositing unit 525B in addition to the elements in the first embodiment.

The temporary recording unit 525A temporarily records a plurality of RAW images transmitted from the terminal A400 or a plurality of RAW images read from the recording unit 502. The plurality of RAW images recorded by the temporary recording unit 525A are a plurality of RAW images obtained by performing continuous shooting at very short time intervals by the camera 401 of the terminal A400. Such continuous shooting at very short time intervals by the camera is generally called burst shooting. By performing burst shooting, it is possible to acquire a group of about ten RAW images per second, for example.

The compositing unit 525B has a function of reading a plurality of RAW images from the temporary recording unit 525A, compositing these RAW images, and outputting one RAW image to the demosaic unit 530. The compositing unit 525B may combine the plurality of RAW images into one RAW image after aligning the plurality of RAW images. In this case, by using one of the plurality of RAW images as a base image, the compositing unit 525B aligns the plurality of RAW images based on the motion vector quantity with respect to a reference image other than the base image. The motion vector quantity is a shift amount between the subject position in the base image and the same subject position in the reference image, and can be derived by using a known method.

The compositing unit 525B can acquire one high-quality image by aligning and compositing the plurality of RAW images. Compositing means blending (for example, weighted averaging) the pixel values of the corresponding pixel positions in a plurality of RAW images. It is known that a digital image captured with high sensitivity has unevenness called high-sensitivity noise. By blending the pixel values of a plurality of images, such high-sensitivity noise can be suppressed (MFNR: Multi Frame Noise Reduction). The compositing unit 525B of the second embodiment can also output one RAW image in which noise is suppressed by aligning and compositing the plurality of RAW images.

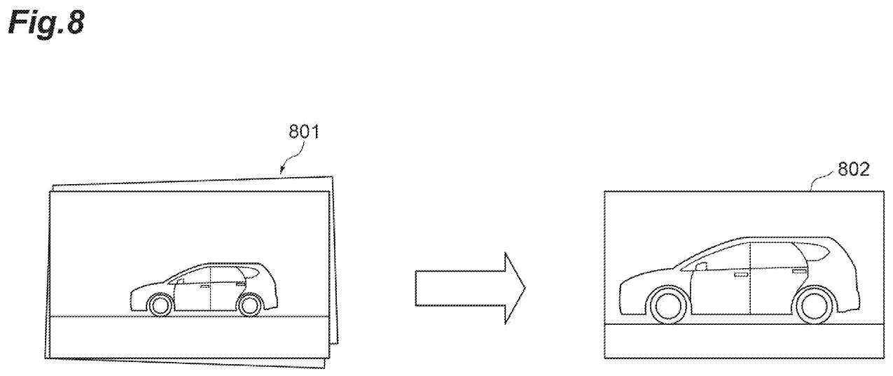

Alternatively, the compositing unit 525B may acquire one high-quality image by performing compositing processing and interpolation processing in combination. FIG. 8 is a schematic diagram showing how a plurality of RAW images 801 are subjected to compositing processing and interpolation processing and one RGB image 802 with improved resolution is output. The interpolation processing is to increase the number of pixels in a pseudo manner, and an image processing technique for improving the resolution by the interpolation processing is generally called super-resolution processing. In addition, a plurality of RAW images are combined by interpolation, and one RGB image is output. In this case, the compositing unit 525B has a function of skipping the processing in the demosaic unit 530 at the subsequent stage and outputting one RGB image with improved resolution to the color correction unit 540.

[Virtual Image Pipeline Process]

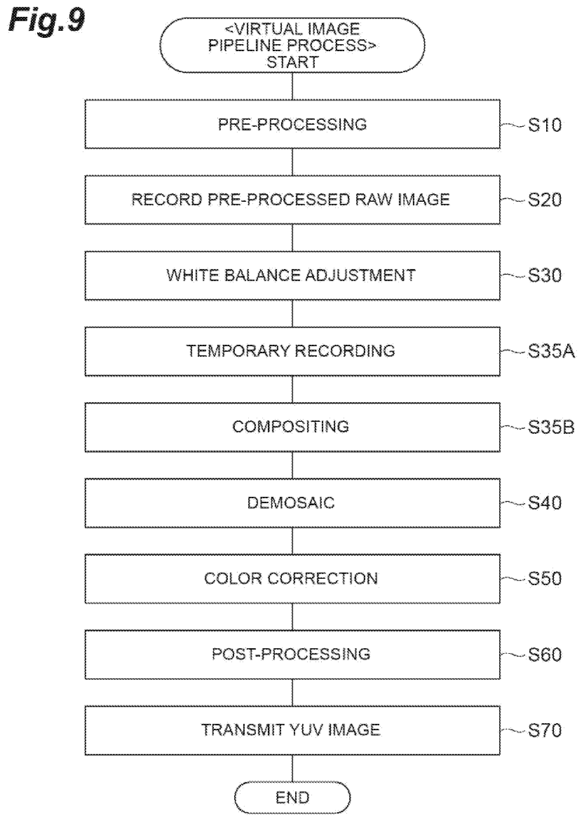

FIG. 9 is a flowchart showing a virtual image pipeline process of the server 500 according to the second embodiment.

In S35A, a plurality of RAW images output from the white balance adjustment unit 520 are sequentially recorded in the temporary recording unit 525A.

In S35B, the compositing unit 525B reads a plurality of RAW images from the temporary recording unit 525A, combines these RAW images, and outputs one RAW image to the demosaic unit 530. Thereafter, the same processing as in the first embodiment is performed.

According to the present embodiment, the server 500 has a function of performing virtual image pipeline processing. In this virtual image pipeline processing, the server 500 performs a plurality of image processes including compositing processing at the RAW image stage on the plurality of RAW images acquired by the burst shooting of the terminal A400, and finally transmits the developed output to the terminal A400. Thus, since the high-load image pipeline processing is performed on the server side, it is not necessary to mount the ISP having a high processing capacity on the terminal. Therefore, the cost of the terminal can be suppressed. In addition, since a server having a higher processing capacity than the ISP performs image processing for compositing a plurality of RAW images in the image pipeline processing, it is possible to simplify the processing on the terminal side while enabling the output of a high-quality image.

### Third Embodiment

When performing image pipeline processing in the ISP, it is desirable to set optimum parameters according to the characteristics of the image sensor and the like in order to obtain a high-quality output. However, many programs running on the ISP are written (hard-coated) by embedding parameters in the source code. Therefore, in order to set the parameters, it is necessary to edit the source code to generate an executable file. In the present embodiment, a method capable of easily setting parameters referred to in the image pipeline processing and a method capable of adaptively selecting appropriate parameters by providing a parameter recording unit 506 in the server 500 will be described. In addition, in the following description and each diagram, the same or equivalent elements are denoted by the same reference numerals, and the same description will not be repeated.

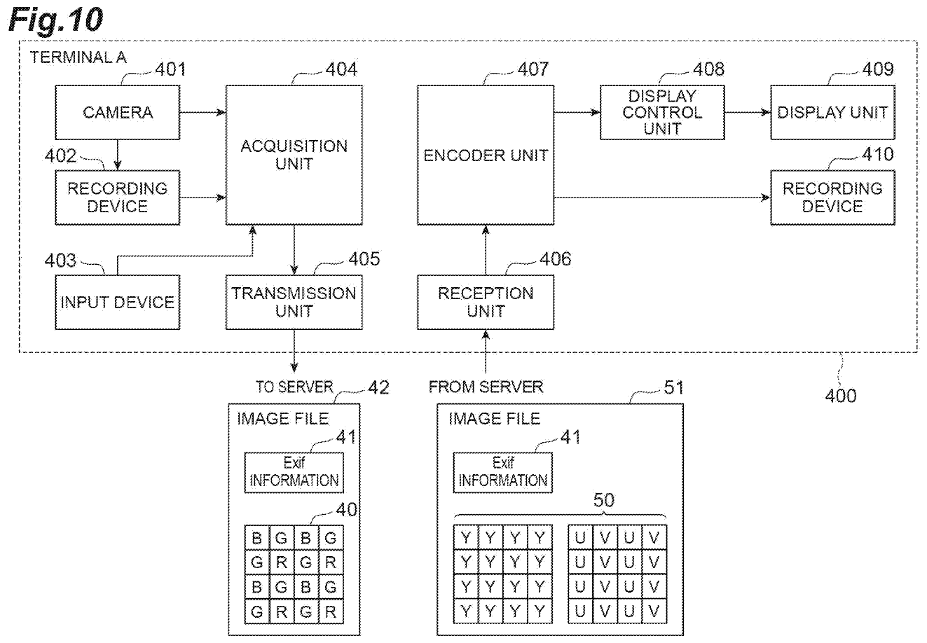

FIG. 10 is a block diagram showing an example of the function of a terminal A400 according to a third embodiment. The terminal A400 of the third embodiment includes the same elements as the terminal A400 of the first embodiment, but the data format for transmission and reception to and from the server 500 is different.

The camera 401 has a function of outputting captured image data and Exif information uniquely corresponding to the captured image data as an image file to the acquisition unit 404 and the recording device 402 each time an image is captured. The Exif information is meta information stored in the image file by the camera 401 based on the Exif (Exchangeable image file format) standard. The Exif information includes information such as “terminal manufacturer”, “terminal model”, “imaging date”, “imaging time”, “aperture value”, “shutter speed”, “ISO sensitivity”, and “imaging light source”. For example, when the “ISO sensitivity” is set in advance by the user operation, the Exif information corresponding to the image captured by the camera 401 includes the value of the set “ISO sensitivity”. In addition, the ISO sensitivity is a standard for photographic film determined by the International Organization for Standardization (ISO), and is an indicator of how weak light a film can record.

The input device 403 receives an input of the set value by the user operation. The set value includes information regarding a light source in imaging, such as “daylight” or “white fluorescent light”. Alternatively, the set value may be information regarding the sensitivity in imaging, for example, “ISO sensitivity”.

The acquisition unit 404 acquires an image file 42 from the camera 401 or the recording device 402. The image file 42 acquired by the acquisition unit 404 includes Exif information 41 and the RAW image 40.

The transmission unit 405 transmits the image file 42 to the server 500.

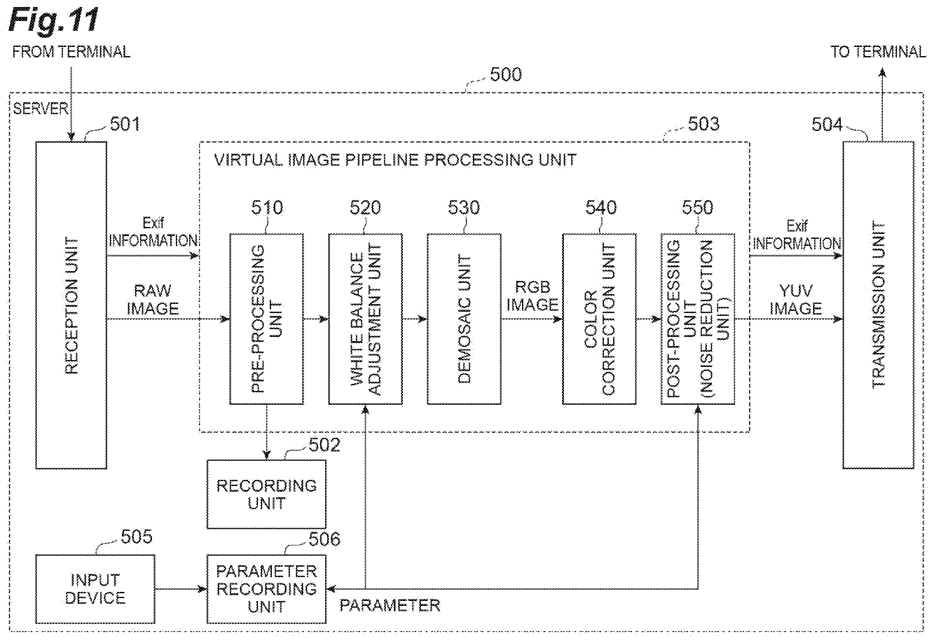

FIG. 11 is a block diagram showing an example of the function of the server 500 according to the third embodiment. The virtual image pipeline processing unit 503 in the third embodiment includes an input device 505 and the parameter recording unit 506 in addition to the elements in the first embodiment.

The reception unit 501 has a function of receiving the image file 42 from the terminal A400. The reception unit 501 has a function of inputting the RAW image 40 into the virtual image pipeline processing unit 503 in a predetermined processing unit (for example, a line, a macro block, or a page). In addition, the reception unit 501 has a function of inputting model information and imaging conditions that are information necessary for image processing in the virtual image pipeline processing unit 503, in the received Exif information 41, to the virtual image pipeline processing unit 503.

The input device 505 receives an input of a parameter table by the operation of a service provider (server administrator). The parameter table of the present embodiment is a table in which parameters referred to in a series of image processing groups in the virtual image pipeline processing unit 503 are stored. The service provider (server administrator) can add a parameter table or edit the contents of the parameter table by operating the input device 505. The parameter recording unit 506 is, for example, a recording medium such as a hard disk. The parameter recording unit 506 can record the parameter table.

The virtual image pipeline processing unit 503 receives a RAW image as an input, performs a series of image processing groups, and outputs a YUV image (color difference image) suitable for compressing the amount of data.

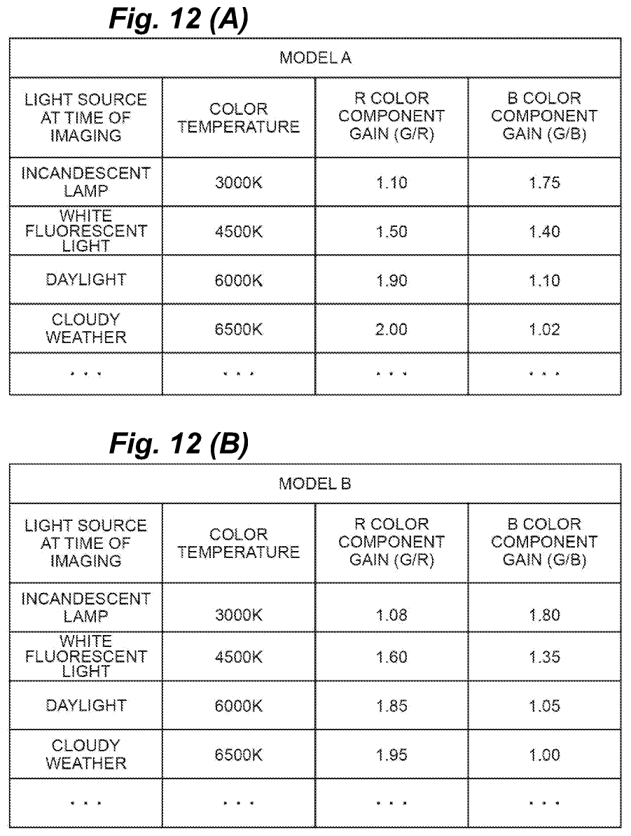

First, the white balance adjustment unit 520 of the third embodiment specifies a parameter table referred to in the white balance adjustment by using the Exif information (model information) acquired from the reception unit 501. FIG. 12 is a diagram showing an example of the parameter table according to the third embodiment. The parameter table shown in FIG. 12 is set in advance for each terminal model, and a parameter table of model A shown in (A) and a parameter table of model B shown in (B) are recorded in the parameter recording unit 506. When the model of the terminal A400 is the model A, the white balance adjustment unit 520 selects the parameter table of the model A.

Then, the white balance adjustment unit 520 derives white balance adjustment parameters (R color component gain, B color component gain) by using the Exif information (imaging conditions) acquired from the reception unit 501. For example, when imaging an achromatic subject with the camera 401, the R color component gain and the B color component gain prepared as white balance adjustment parameters are values to make the ratio of the R color component, the G color component, and the B color component be 1:1:1. In the parameter table of the model A, the R color component gain and the B color component gain are recorded in association with each light source type. When the light source at the time of imaging is “daylight”, the white balance adjustment unit 520 obtains an output by multiplying the R color component, among the input RGB color components, by the R color component gain “1.90” and multiplying the B color component by the B color component gain “1.10”.

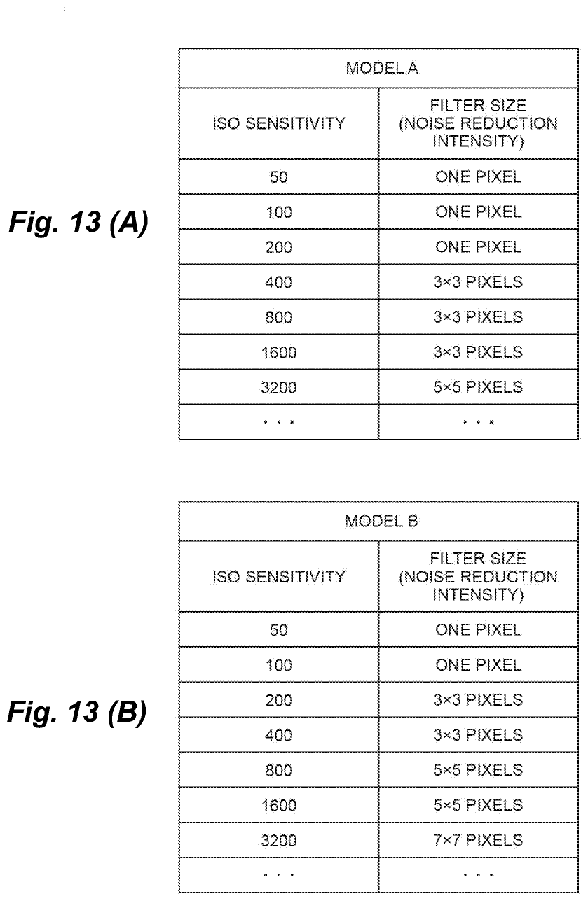

The post-processing unit 550 of the third embodiment has a function of reducing noise in the RGB image. First, the post-processing unit 550 specifies a parameter table referred to in noise reduction by using the Exif information (model information) acquired from the reception unit 501. FIG. 13 is a diagram showing an example of the parameter table according to the third embodiment. The parameter table shown in FIG. 13 is set in advance for each terminal model, and a parameter table of model A shown in (A) and a parameter table of model B shown in (B) are stored in the parameter recording unit 506. When the model of the terminal A400 is the model A, the post-processing unit 550 selects the parameter table of the model A.

Then, the post-processing unit 550 derives a noise reduction parameter (noise reduction intensity) by using the Exif information (imaging conditions) acquired from the reception unit 501. The noise reduction intensity is adjusted, for example, by changing the size of a smoothing filter. When the size is “1”, smoothing is performed only for one pixel of interest, so that noise reduction processing is not substantially performed. When the size is “3×3”, smoothing is performed on 3×3 pixels centered on the pixel of interest. When the size is “5×5”, smoothing is performed on 5×5 pixels centered on the pixel of interest. As described above, the larger the size of the smoothing filter, the higher the noise removal intensity. However, if the noise removal intensity is increased, an edge portion included in the RGB image may also be smoothed. For this reason, the scene analysis of the RGB image may be performed in advance to increase the noise removal intensity in a flat portion, such as the blue sky, and decrease the noise removal intensity in an edge portion, such as the contour of the human face. In the parameter table of the model A, these sizes are stored in association with each ISO sensitivity value. When the ISO sensitivity at the time of imaging is “400”, the post-processing unit 550 performs smoothing on the RGB image by using a smoothing filter having a size of “3×3 pixels” to obtain an output. In addition, the post-processing unit 550 converts the RGB image subjected to the noise reduction processing into a YUV image, and outputs the YUV image to the transmission unit 504.

The transmission unit 504 transmits an image file 51, which includes the YUV image 50 processed by the virtual image pipeline processing unit 503 and the Exif information 41 associated with the RAW image 40 before processing, to the terminal A400.

[Virtual Image Pipeline Process]

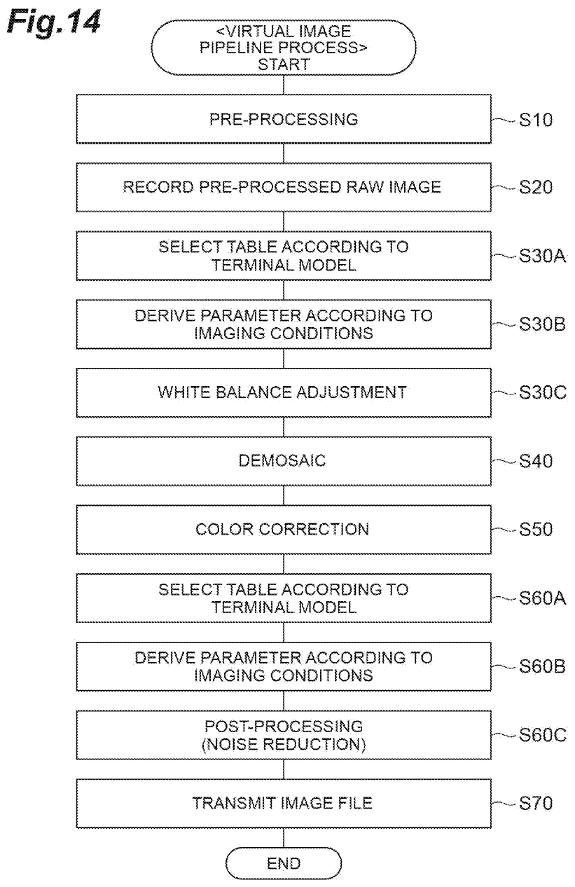

FIG. 14 is a flowchart showing a virtual image pipeline process of the server 500 according to the third embodiment.

In S30A, the white balance adjustment unit 520 first selects a parameter table referred to in the white balance adjustment by using the Exif information (model information) acquired from the reception unit 501.

In S30B, the white balance adjustment unit 520 derives white balance adjustment parameters (R color component gain, B color component gain) by using the Exif information (imaging conditions) acquired from the reception unit 501.

In S30C, the white balance adjustment unit 520 performs white balance adjustment processing based on the parameters derived in S30B.

Then, in S60A, the post-processing unit 550 first selects a parameter table referred to in noise reduction processing by using the Exif information (model information) acquired from the reception unit 501.

In S60B, the post-processing unit 550 derives a noise reduction parameter (noise reduction intensity) by using the Exif information (imaging conditions) acquired from the reception unit 501.

In S60C, the post-processing unit 550 performs noise reduction processing based on the parameters derived in S60B. In addition, the post-processing unit 550 converts the RGB image subjected to the noise reduction processing into a YUV image, and outputs the YUV image to the transmission unit 504.

In S70, the transmission unit 504 transmits the image file 51, which includes the YUV image 50 processed by the virtual image pipeline processing unit 503 and the Exif information 41 associated with the RAW image 40 before processing, to the terminal A400. Thereafter, the same processing as in the first embodiment is performed.

According to the present embodiment, in addition to the effects of the first and second embodiments, the following effects are obtained. That is, by providing the parameter recording unit 506 in the server 500, the parameters referred to in the image pipeline processing can be easily set. In addition, since the parameters recorded in the parameter recording unit 506 are selected according to the information (Exif information 41) associated with the RAW image 40, the optimum parameters in the image pipeline processing can be adaptively selected.

In one embodiment, the information associated with the RAW image is the model information of the terminal A400. Therefore, it is possible to adaptively select the optimum parameters according to the characteristics of the model in the image pipeline processing.

In one embodiment, the information associated with the RAW image is the imaging conditions of the RAW image 40. Therefore, it is possible to adaptively select the optimum parameters according to the imaging conditions of the RAW image 40 in the image pipeline processing.

[Program]

A program for functioning as the server 500 will be described. The program includes a main module, a reception module, a recording module, a virtual image pipeline module, a transmission module, an input module, a parameter recording module, a pre-processing module, a white balance adjustment module, a temporary recording module, a compositing module, a demosaic module, a color correction module, and a post-processing module. The main module is a part that performs overall control of the device. Functions realized by executing the reception module, the recording module, the virtual image pipeline module, the transmission module, the input module, the parameter recording module, the pre-processing module, the white balance adjustment module, the temporary recording module, the compositing module, the demosaic module, the color correction module, and the post-processing module are the same as the functions of the reception unit 501, the recording unit 502, the virtual image pipeline processing unit 503, the transmission unit 504, the input device 505, the parameter recording unit 506, the pre-processing unit 510, the white balance adjustment unit 520, the temporary recording unit 525A, the compositing unit 525B, the demosaic unit 530, the color correction unit 540, and the post-processing unit 550 of the server 500 described above.

### REFERENCE SIGNS LIST

400: terminal A, 401: camera, 500: server, 501: reception unit, 502: recording unit, 503: virtual image pipeline processing unit, 504: transmission unit.

1. A server device, comprising:
a reception unit configured to receive a RAW image from a terminal; and
an image pipeline processing unit configured to develop the RAW image,
wherein the image pipeline processing unit has:
a first image processing unit configured to perform one or more image processes including at least pixel value adjustment on the RAW image and outputting an image-processed RAW image; and
a second image processing unit configured to perform one or more image processes including at least demosaic on the RAW image image-processed by the first image processing unit and outputting a developed image.

2. The server device according to claim 1,
wherein the first image processing unit includes a white balance adjustment or a black level adjustment.

3. A server device, comprising:
a reception unit configured to receive a plurality of RAW images from a terminal; and
an image pipeline processing unit configured to develop the plurality of RAW images,
wherein the image pipeline processing unit has:
a first image processing unit configured to perform one or more image processes including at least combination of the plurality of RAW images and outputting one image-processed RAW image; and
a second image processing unit configured to perform one or more image processes including at least demosaic on the one RAW image image-processed by the first image processing unit and outputting a developed image.

4. The server device according to claim 3,
wherein the one RAW image image-processed by the first image processing unit has less noise than the plurality of RAW images.

5. The server device according to claim 3,
wherein the combination of the plurality of RAW images includes pixel interpolation, and
the one RAW image image-processed by the first image processing unit has a higher resolution than the plurality of RAW images.

6. The server device according to claim 1,
wherein the second image processing unit includes a color space conversion for converting a color space from a demosaic RGB image to a YUV image.

7. The server device according to claim 1, further comprising:
a transmission unit configured to transmit an image developed by the image pipeline processing unit to the terminal.

8. The server device according to claim 1, further comprising:
a recording unit configured to record one or more RAW images received from the terminal.

9. The server device according to claim 8,
wherein the image pipeline processing unit reads one or more RAW images recorded in the record unit when predetermined conditions are satisfied, and outputs an image developed by the first image processing unit and the second image processing unit that perform image processing on the read one or more RAW images.

10. The server device according to claim 9,
wherein the predetermined conditions are that an input of an instruction by a user operation has occurred.

11. The server device according to claim 1, further comprising:
a record unit configured to record an image developed by the image pipeline processing unit.

12. The server device according to claim 1, further comprising:
a parameter record unit configured to record a parameter referred to in at least one image process in the image pipeline processing unit.

13. The server device according to claim 12,
wherein the parameter referred to in the at least one image process is selected according to information associated with one or more RAW images received from the terminal.

14. The server device according to claim 13,
wherein the information associated with one or more RAW images received from the terminal is model information of the terminal.

15. The server device according to claim 13,
wherein the information associated with one or more RAW images received from the terminal is imaging conditions of the RAW image.

16. A non-transitory computer-readable media including a program for causing a computer to function as each unit of the server device according to claim 1.

17. The server device according to claim 3,
wherein the second image processing unit includes a color space conversion for converting a color space from a demosaic RGB image to a YUV image.

18. The server device according to claim 3, further comprising:
a transmission unit configured to transmit an image developed by the image pipeline processing unit to the terminal.

19. The server device according to claim 3, further comprising:
a record unit configured to record one or more RAW images received from the terminal.

20. A terminal, comprising:
a camera;
a transmission unit configured to transmit one or more RAW images shot by the camera; and
a receiving unit configured to receive the RAW image developed without reducing the image size.
